(19) United States
(12) Patent Application Publication
(10) Pub. No.: US 2026/0210387 A1
(43) Pub. Date: Jul. 23, 2026

(54) TWO SHAFT ALIGNMENT DEVICE

(71) Applicant: Toyota Motor Engineering & Manufacturing North America, Inc., Plano, TX (US)

(72) Inventors: Greg DK Lesser, London (CA); Annette L. Kotnik, London (CA); Ismail Abdelhalim, London (CA); Krish Modi, Kitchener (CA); Iain C. Kilgour, Woodstock (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/026,855

(22) Filed: Jan. 17, 2025

(51) Int. Cl. F16B 7/04

(52) U.S. Cl. CPC F16B 7/0406

(57) ABSTRACT

A device described herein aligns two components to be joined, ensuring the components don't twist relative to one another. In one embodiment, the device includes a first shaft insertable through first alignment apertures in components to be joined. A sleeve coaxially surrounds a middle portion of the first shaft. The sleeve abuts a first component when the first shaft is inserted through the first alignment apertures. The device also includes a handle attached to the first shaft. The device also includes a detachable alignment device. The detachable alignment device includes 1) a collar attachable around the first shaft, 2) an arm extending perpendicularly from the collar, and 3) a second shaft extending perpendicularly from the arm. The second shaft is insertable into second alignment apertures in the components.

### TECHNICAL FIELD

The subject matter described herein relates, in general, to joining or affixing components together and, more particularly, to ensuring alignment of the two components via a two-shaft alignment device, which in some cases is adjustable.

### BACKGROUND

Manufacturing involves the assembly of multiple components into a final product. A common manufacturing process is to join components to one another via fasteners such as bolts or screws. To join two components, a bolt may be passed through an aperture in a first component and into a threaded hole on a second component. The bolt is rotated such that the helical threads on the bolt enmesh with helical threads of the hole to draw the bolt towards the second component. The bolt may be tightened such that the first component is sandwiched between the second component and the head of the bolt and firmly affixed to the second component.

In one particular example, a vehicle may include a curtain side airbag. In general, a curtain side airbag is affixed to a headliner (e.g., a ceiling frame member) of a vehicle. Responsive to a side impact collision, the curtain side airbag deploys and unrolls to protect a passenger from contact with hard side surfaces such as the door frame, fascia, or window. The curtain side airbag may include a metal bracket that is affixed to the vehicle frame during manufacturing.

### SUMMARY

In one embodiment, an example device improves the alignment of components while joining the components together. The device includes a first shaft insertable through first alignment apertures in components to be joined. A sleeve coaxially surrounds a middle portion of the first shaft. The sleeve abuts a first component when the first shaft is inserted through the first alignment apertures. The device also includes a handle attached to the first shaft. The device also includes a detachable alignment device. The detachable alignment device includes 1) a collar attachable around the first shaft, 2) an arm extending perpendicularly from the collar, and 3) a second shaft extending perpendicularly from the arm. The second shaft is insertable into second alignment apertures in the components.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B are isometric views of the two shaft alignment device according to embodiments described herein.

FIGS. 2A-2C illustrate the alignment and joining of two components via the two shaft alignment device according to embodiments described herein.

FIGS. 3A and 3B are cross-sectional views of the two shaft alignment device according to embodiments described herein.

FIGS. 4A-4E are isometric views of a two shaft alignment device with extendable arms according to embodiments described herein.

### DETAILED DESCRIPTION

A device associated with improving component alignment during manufacturing is disclosed herein. As previously described, it is not uncommon for two components to be joined to one another during a manufacturing or assembly operation. For example, as described above, a curtain side airbag module may be affixed to a frame member of a vehicle. These, or other components, may be affixed to one another via a rotating fastener such as a bolt. That is, to join the two components together, the bolt is rotated to sandwich one of the components between a bolt head and the other component.

However, if the holes are misaligned, the bolts may engage with the hole at a non-straight angle. This may result in cross-threading where the threads of the bolts and threads of the hole are misaligned, which can damage the threading of the bolt or hole permanently and may compromise the structural integrity of the bolt or hole and/or the holding force of the joint.

Moreover, some components are difficult to hold together while joining. For example, the aforementioned curtain side airbag may be installed on the underside of the vehicle roof frame member. Accordingly, to install the curtain side airbag, a technician may need to hold the curtain side airbag module in place overhead with one hand while placing a bolt and tightening the bolt with the other hand. This is a complex maneuver and may require two technicians to install.

Accordingly, the present specification describes an alignment tool that aligns the two components to be joined and temporarily holds the components in place while the components are joined together. Specifically, the alignment device includes a pin inserted through alignment holes in the components, which are separate from the holes that are to receive bolts. An insertion end of the pin includes retractable ball bearings that, when inserted into an alignment hole on the second component, press against the interior walls of the threaded hole to hold the first component in place relative to the second component.

However, a single insertion pin may allow the two components to twist relative to one another, albeit slightly. Specifically, upon tightening the first component to the second component, the first component may twist relative to the second component such that other bolt holes in the two components are misaligned. That is, secondary attachment holes in the first and second components may be slightly misaligned due to tightening a bolt in primary attachment holes in the first and second components. Misalignment of the secondary attachment holes may result in cross-threading of inserted bolts. Even if the bolts/holes are not cross-threaded, the misalignment may increase the resistance to bolt tightening, such that a technician may have to retract, either entirely or partially, the bolt from the threaded hole and attempt to re-align the bolt with the hole. This may be time-consuming, especially when it occurs for each of multiple components joined in a complex product, such as a vehicle. Thus, these complications may result in wasted material, reduced throughput, and other manufacturing inefficiencies.

Accordingly, the present specification describes an attachment to the single alignment pin that provides a second alignment point. Specifically, the alignment device of the present specification includes a bent arm that extends away from, and has a second alignment shaft that is parallel to, the first alignment shaft. Both shafts are then inserted into pairs of alignment holes in the first and second components. The two alignment shafts prevent the aforementioned cross-thread inducing rotation of the components to be joined. In one particular example, the device aligns an airbag module with the frame member of a vehicle.

This second shaft is detachable from the first shaft. Specifically, the second shaft includes a collar that tightens around the first shaft. This second shaft stabilizes the to-be-joined components and prevents them from twisting while secured into place. Thus, the components are properly joined, and the likelihood of damage to the components and fasteners is reduced.

In one example, the arms of the 90-degree second shaft may be extendable. That is, the distance between the tip of the second shaft and the tip of the first shaft is adjustable, as is the length of the second shaft that protrudes into the second alignment holes of the first and second components. Moreover, the angle of the second shaft to the first shaft is also adjustable. Accordingly, the present alignment device provides customizable two-anchor alignment of two components to be joined. Moreover, the separability of the second shaft allows it to be swapped out as the primary shaft wears out during use.

In this way, the disclosed device aligns and holds in place two components to be joined, and specifically does so in a way to prevent rotation of the components when one fastener (e.g., bolt) is inserted into first bolt holes of the components, which rotation may result in misalignment of other bolt holes, cross-threading, and material and time waste.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

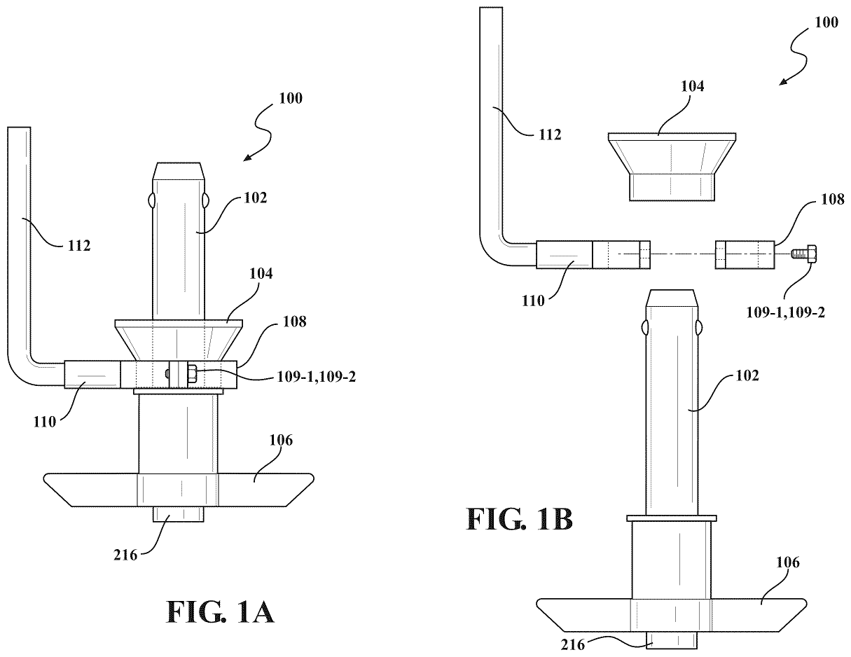

FIGS. 1A and 1B are isometric views of the two shaft alignment device 100 according to embodiments described herein. Specifically, FIG. 1A is an isometric assembled view of the two shaft alignment device 100 and FIG. 1B is an isometric exploded view of the two shaft alignment device 100.

As described above, the two shaft alignment device 100 ensures that two components are aligned with one another during joining. Specifically, the two components may rotate relative to one another when held in place at a single point of contact. Specifically, the two components may rotate about a pivot point defined by the single anchor. Accordingly, the two shaft alignment device 100 includes two shafts 102 and 112 that prevent the relative rotation of two to-be-joined components.

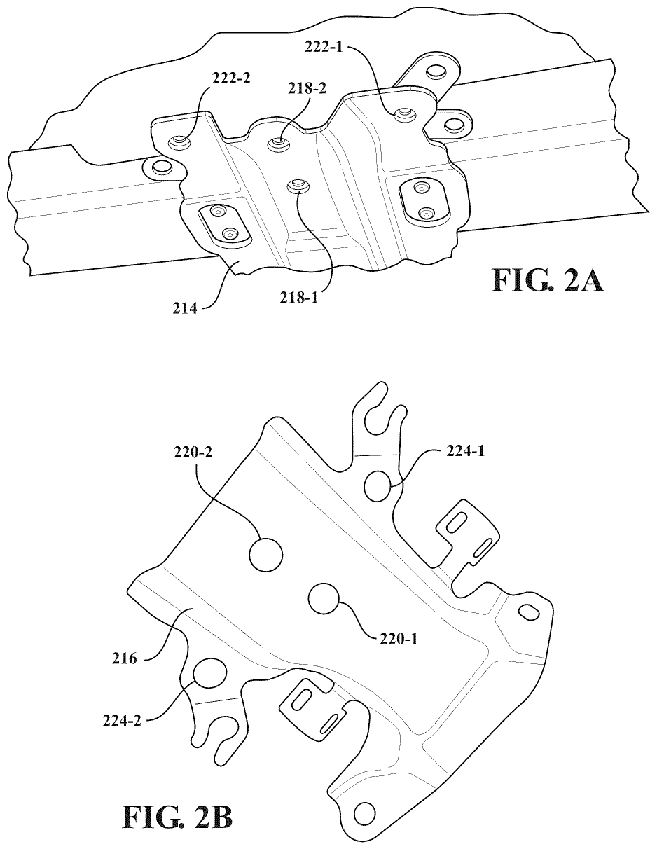

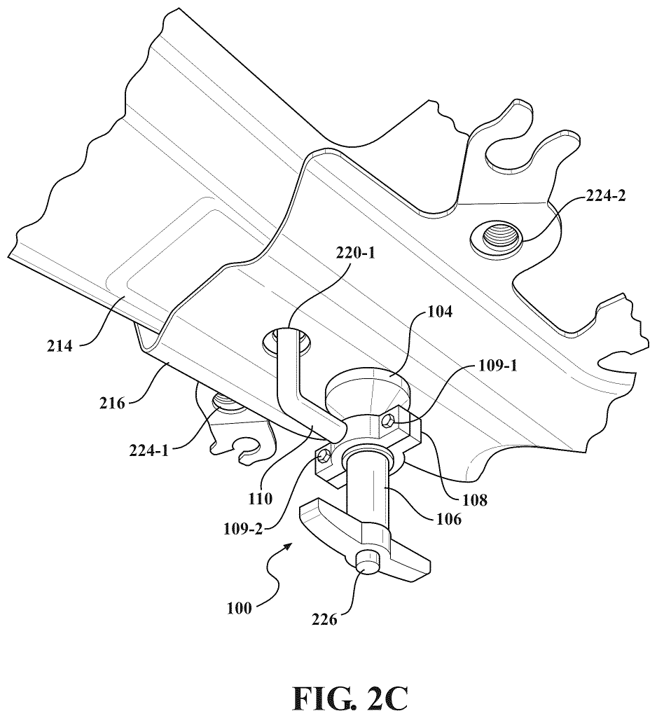

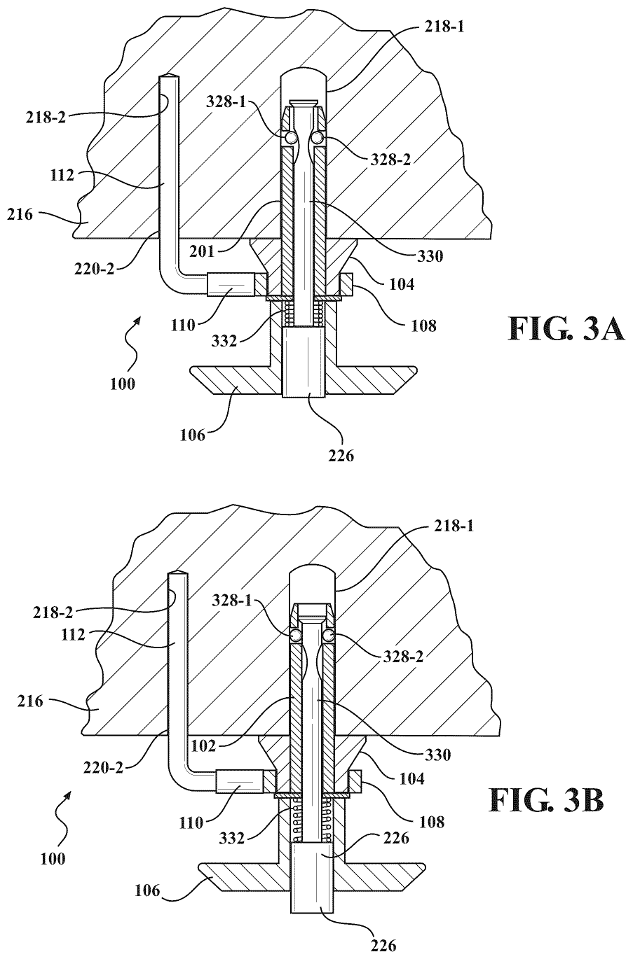

The two shaft alignment device 100 includes a first shaft 102 that is insertable through first alignment apertures in components to be joined. That is, as depicted in FIGS. 2A-3B, each component to be joined may include apertures that align with one another. The first shaft 102 may be inserted through a pair of these apertures during alignment. In a specific example, the first shaft 102 sits within a pocket, hole, or recess in the second component to be joined. As depicted below in FIGS. 3A and 3B, end-mounted retractable ball bearings on the first shaft 102 may interact with the interior walls of the pocket to hold the first component in place against the second component. The first shaft 102 may have a generally longitudinal shape.

The two shaft alignment device 100 also includes a sleeve 104 that coaxially surrounds a middle portion of the first shaft 102. That is, the first shaft 102 may have a distal portion, which is inserted into the apertures, and a handle 106 that an operator grasps to position the two shaft alignment device 100 in place. The sleeve 104 may be positioned along the first shaft 102 between the distal portion and the handle 106. When the first shaft 102 is positioned in the first alignment apertures, the sleeve 104 abuts the first component of the pair of components to be joined. The sleeve 104, therefore, serves as a stop to prevent the first shaft 102 from being over-inserted into the second component pocket. As depicted in FIG. 1A, the sleeve 104 may also serve as an attachment point for the detachable alignment device that provides the second anchor point between the two to-be-joined components. While the first shaft 102 may be formed of a metallic material such as hardened steel or aluminum, the sleeve 104 may be a plastic material. For example, the sleeve 104 may be a plastic three-dimensionally (3D) printed component.

The two shaft alignment device 102 also includes a handle 106 attached to the first shaft 102. In one example, the handle 106 and first shaft 102 are a single integrated component with the sleeve 104 3D printed around or otherwise attached to the middle portion of the first shaft 102.

A user grasps the handle 106 to position the two shaft alignment device 100 in alignment apertures. In an example, the handle 106 may be a T-shaped handle 106 to facilitate one-handed positioning of the two shaft alignment device 100. That is, a user may align the two components to be joined with one hand and with another hand may insert the shafts 102 and 112 into respective alignment apertures. As depicted below in FIGS. 3A and 3B, the handle 106 may include a push button to lock the two shaft alignment device 100 in place. The T-shaped handle 106 may facilitate the one-handed simultaneous holding of the two shaft alignment device 100 and the activation of the locking mechanism.

The two shaft alignment device 100 includes a detachable alignment device to provide the second anchor point. The detachable alignment device includes a collar 108 attachable around the first shaft 102, and in an example, around the sleeve 104 surrounding the first shaft 102. In general, the collar 108 includes two semi-circular brackets that are joinable around the first shaft 102, either directly or indirectly via the sleeve 104 via a pair of fasteners 109-1 and 109-2. That is, the collar 108 includes two halves, each formed in a semi-circle that, when joined together, form a circular opening that matches the diameter of the first shaft 102 or sleeve 104 to which it is attached. A first half may have unthreaded through holes, while the second half may have threaded pockets. Fasteners 109-1 and 109-2, such as bolts, may then be inserted through the unthreaded holes in the first half and into corresponding threaded holes in the second half. Via rotation, the fasteners 109-1 and 109-2 may draw and tighten the first half to the second half around the middle portion of the first shaft 102 or sleeve. As such, the detachable alignment device is selectively removable from the first shaft 102. Accordingly, when either the first shaft 102 or the second shaft 112 becomes damaged, these components may be individually replaceable rather than requiring the entire two shaft alignment device 100 to be replaced when just a component of such becomes damaged. Moreover, it may be that detachable alignment devices with different characteristics may be attached to the first shaft 102/sleeve 104. For example, different detachable alignment devices may include second shafts 112 with different lengths or diameters, depending on the use. Accordingly, these differently sized and dimensioned detachable alignment devices may be interchanged on the first shaft 102/sleeve 104. As with the first shaft 102, the collar 108 may be formed of a rigid material such as steel or aluminum.

The detachable alignment device includes an arm 110 extending perpendicularly from the collar 108. In general, the arm 110 separates the second shaft 112 insertion end from the first shaft 102 insertion end. The length of the arm 110 may be selected based on the positioning of component alignment apertures that receive the first and second shafts 102 and 112, respectively. The detachable alignment device also includes a second shaft 112 that extends perpendicularly from the arm 110 and, in some examples, parallel with the first shaft 102. That is, the arm/second shaft may form an L-shaped arm member.

The second shaft 112 is insertable into the second alignment apertures in the components to be joined. That is, in addition to the first alignment apertures, each component may include a second alignment aperture. The first shaft 102 is insertable into the first alignment apertures and the second shaft 112 is insertable into the second alignment apertures. Thus, the two shaft/aperture interactions anchor the two components relative to one another to prevent the rotation of the two components relative to one another. As depicted in FIG. 1B, the collar 108, arm 110, and second shaft 112 may be an integrated component formed of a single material such as steel or aluminum.

FIGS. 2A-2C illustrate the alignment and joining of two components via the two shaft alignment device 100 according to embodiments described herein. In the example depicted in FIGS. 2A-2C, the two components include a vehicle ceiling frame member 214 (or headliner), as depicted in FIG. 2A and a curtain side airbag bracket 216, as depicted in FIG. 2B. In general, the curtain side airbag is an airbag that unrolls or otherwise deploys over an interior side portion of a vehicle door during a collision to protect the user from colliding with hard door/frame members. The curtain side airbag is attached to the vehicle via the curtain side airbag bracket 216, which is bolted or otherwise joined to the ceiling frame member 214. As depicted in FIG. 2C, the curtain side airbag bracket 216 may be joined to the ceiling frame member 214 in an overhead position. This may make assembly difficult as the operator may have to hold the curtain side airbag bracket 216 in place with one hand while aligning bolts to join the two components and handling the joining tool with the other hand. The two shaft alignment device 100 of the present specification holds the curtain side airbag bracket 216 in place against the ceiling frame member 214, thus freeing both hands of the operator to align bolts and operate the joining tool.

As described above, each component to be joined may include a pair of alignment apertures. Specifically, the first component (e.g., the curtain side airbag bracket 216 depicted in FIG. 2B) may include a first alignment aperture 220-1 and a second alignment aperture 220-2, and the second component (e.g., the ceiling frame member 214 depicted in FIG. 2A) may include a first alignment aperture 218-1 and a second alignment aperture 218-2. In an example, these alignment apertures 218-1, 218-2, 220-1, and 220-2 may be existing apertures in the components, for example that are used to join other components at the junction. Note that the alignment apertures 218-1, 218-2, 220-1, and 220-2 may be distinct from joining apertures 222-1, 222-2, 224-1, and 224-2 in respective components, which joining apertures 222-1, 222-2, 224-1, and 224-2 may receive the fasteners that join the two components together.

Accordingly, as depicted in FIG. 2C, an operator aligns the two components (e.g., the curtain side airbag bracket 216 and the ceiling frame member 214). The operator may then insert the first shaft 102 of the two shaft alignment device 100 into the respective first alignment apertures 220-1 and 218-1 (not shown in FIG. 2C) and insert the second shaft 112 (not shown in FIG. 2C) into the respective second alignment apertures 220-2 and 218-2 (not shown in FIG. 2C). During insertion, the operator may depress the push button 226 on the handle 106 to selectively retract the retractable ball bearings as depicted in FIG. 3A. Were the retractable ball bearings extended, the first shaft 102 may be prevented from sliding into the pocket on the second component (e.g., the ceiling frame member 214). As described above, the sleeve 104 may abut the first component (e.g., the curtain side airbag bracket 216) when fully inserted. The component-facing surface of the sleeve 104 may provide a surface area that holds the first component in place and may also gauge the insertion depth of the first shaft 102 and the second shaft 112.

Once the first shaft 102 and second shaft 112 are fully seated within the respective alignment apertures 218-1, 218-2, 220-1, and 220-2, the operator may release the two components (e.g., the curtain side airbag bracket 216 and the ceiling frame member 214), which are now held in place by the two shaft alignment device 100 and may insert fasteners into the joining apertures 222-1 (not shown in FIG. 2C), 222-2 (not shown in FIG. 2C), 224-1, and 224-2. Given that there are two anchor points, the curtain side airbag bracket 216 does not rotate relative to the ceiling frame member 214, even when a bolt is tightened into a respective joining aperture. As described above, the relative rotation of these two components may result in cross-threading, which can lead to compromised strength of the components and/or increased and wasteful assembly time. Accordingly, the two shaft alignment device 100 of the present specification promotes the efficient and cost-effective joining of any two components, such as a curtain-side airbag bracket 216 to a ceiling frame member 214 of a vehicle.

FIGS. 3A and 3B are cross-sectional views of the two shaft alignment device 100 according to embodiments described herein. Specifically, FIG. 3A depicts a cross-sectional view of the two shaft alignment device 100 in an unlocked or insertion state, and FIG. 3B depicts a cross-sectional view of the two shaft alignment device 100 in a locked or inserted state. As described above and as depicted in FIGS. 3A and 3B, the first shaft 102 may be inserted into first alignment apertures 220-1 and 218-1 in the first component (e.g., the curtain side airbag bracket 216) and second component (e.g., the ceiling frame member 214), respectively, while the second shaft 112 may be inserted into second alignment apertures 220-2 and 218-2 in the first component (e.g., the curtain side airbag bracket 216) and second component (e.g., the ceiling frame member 214), respectively. As depicted in FIGS. 3A and 3B, the apertures in the second component may be pockets. In one specific example, the apertures in the second component may be threaded holes to receive bolts to join other components to the second and/or first components. FIGS. 3A and 3B also depict the sleeve 104, which serves as a depth gauge for inserting the shafts 102 and 112 into respective alignment apertures 218-1, 218-2, 220-1, and 220-2.

The sleeve 104 may also provide an interface against which the first component (e.g., the curtain side airbag bracket 216) is held in place adjacent to the second component (e.g., the ceiling frame member 214). That is, as described above, in addition to lining up the two components to be joined and preventing the relative rotation of such, the two shaft alignment device 100 may also hold the two components in place together such that the operator may have both hands free to join the two components via inserting fasteners such as bolts through the respective joining apertures 222-1, 222-2, 224-1, and 224-2. To hold the two components together, the two shaft alignment device 100 may include a pair of retractable ball bearings 328-1 and 328-2 extending out a circumference of an insertion end of the first shaft 102. The pair of retractable ball bearings 328-1 and 328-2 press against the interior walls of a pocket of the second component when the first shaft 102 is inserted through the first alignment apertures 218-1 and 220-1, as depicted in FIG. 3B. That is, when extended, a friction interface between the retractable ball bearings 328-1 and 328-2 and the interior walls of the pocket hold the first component (e.g., the curtain side airbag bracket 216) in place against the second component (e.g., the ceiling frame member 214) during installation.

The two shaft alignment device 100 also includes a push button 226 on the handle 106 to selectively retract the pair of retractable ball bearings 328-1 and 328-2 within an interior volume of the first shaft 102, allowing the removal and insertion of the two shaft alignment device 100. Accordingly, as depicted in FIG. 3A, the depression of the push button 226 extends a rod 330 within the interior of the first shaft 102, which rod 330 is coupled to the push button 226. The rod 330 includes depressions that receive the retractable ball bearings 328-1 and 328-2. The extension of rod 330 aligns the depressions with the retractable ball bearings 328-1 and 328-2 so that no external force pushes the retractable ball bearings 328-1 and 328-2 outward. An operator may easily insert or remove the two shaft alignment device 100 without this external force.

By comparison, when the push button 226 is released, as depicted in FIG. 3B, a spring 332 biases the rod 330 backward (i.e., in the direction indicated by the arrow in FIG. 3B) such that the retractable ball bearings 328-1 and 328-2 are no longer aligned with the depressions and an outward force exerted by the larger diameter of the rod 330 locks the retractable ball bearings 328-1 and 328-2 in an extended position. In this position, the friction interface between the retractable ball bearings 328-1 and 328-2 with the interior walls of the pocket in the second component and the interface between the sleeve 104 and the first component hold the first component in place adjacent to the second component.

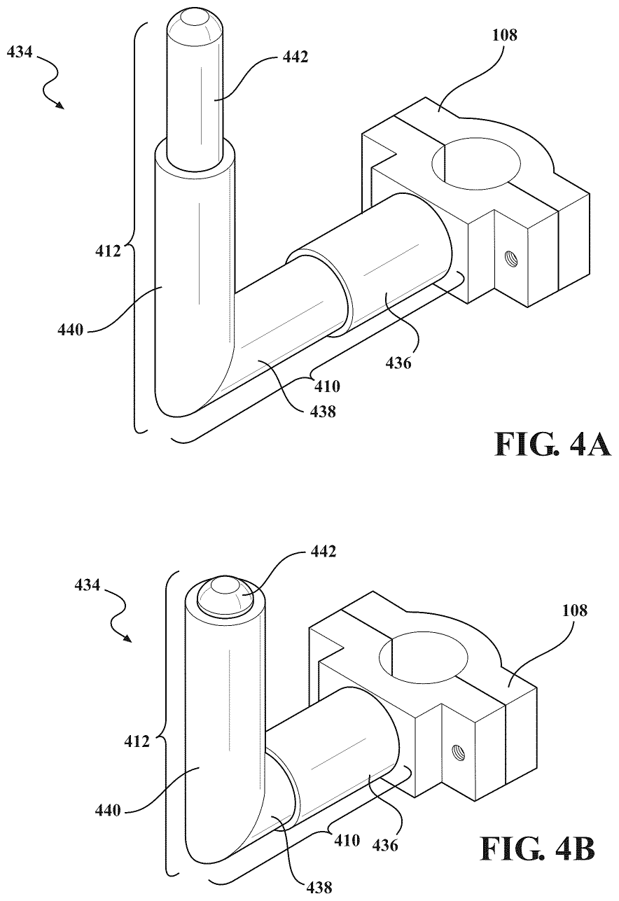

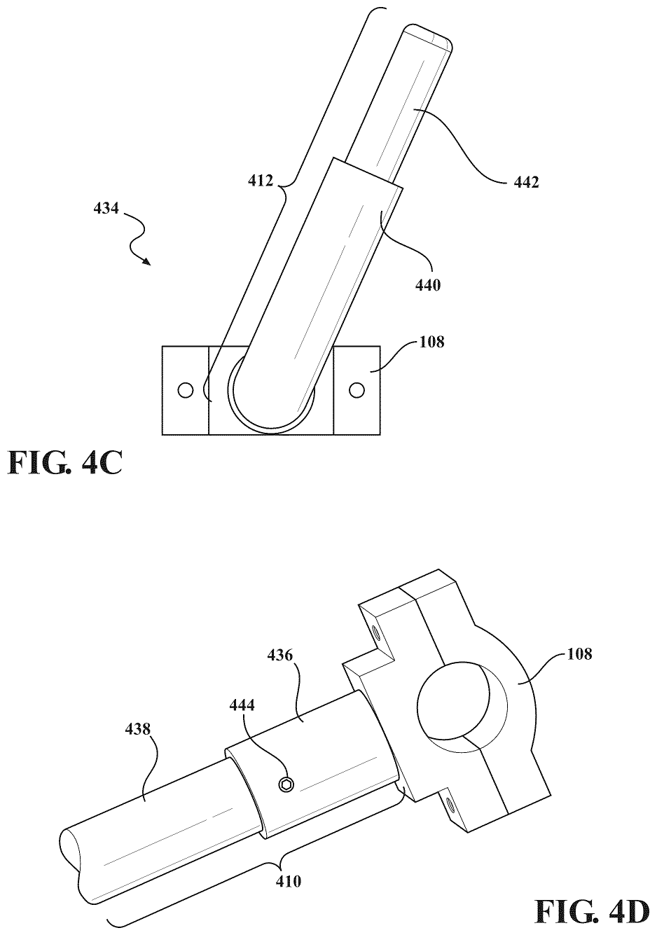

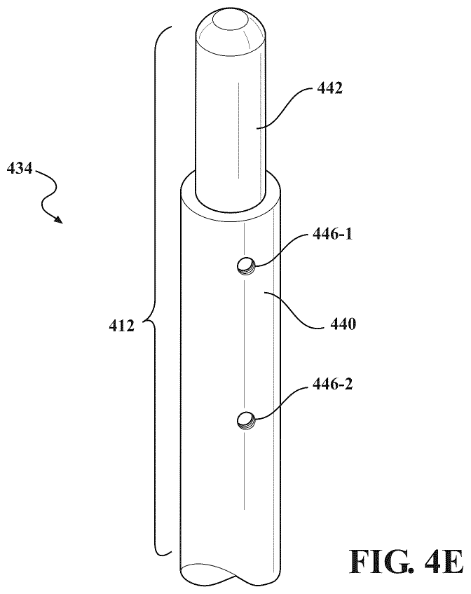

FIGS. 4A-4E are isometric views of a detachable alignment device 434 with extendable arms according to embodiments described herein. As described above, the arm may define a distance between the first shaft 102 and the second shaft and the respective alignment apertures. In the example device depicted in FIGS. 4A-4E, the arm 410 is extendable away from the collar 108 in a direction perpendicular to the first shaft 102. As such, the second shaft 412 may be positioned any distance from the first shaft 102. To facilitate the extension, the arm 410 may include an arm rod 438 inserted into, and translational relative to, an arm socket 436. For example, when the arm rod 438 is more fully seated into the arm socket 436, as depicted in FIG. 4A, the second shaft 412 is closer to the first shaft 102 on account of the shortened length of the arm 410. By comparison, when the arm rod 438 is more fully extended from the arm socket 436, as depicted in FIG. 4B, the second shaft 412 is farther away from the first shaft 102 on account of the increased length of the arm 410. Accordingly, the detachable alignment device 434, and the two shaft alignment device 100 of which the detachable alignment device 434 is a component, are customizable based on the characteristics of the components to be joined and the respective alignment apertures. That is, the two shaft alignment device 100 in the example depicted in FIGS. 4A-4E may be adjustable to accommodate different scenarios.

Additionally, the arm rod 438 may be rotatable relative to the arm socket 436. Due to this interaction between the arm rod 438 and the arm socket 436, the second shaft 412 may be rotated about the longitudinal axis of the arm rod 438 and the arm socket 436. For example, as depicted in FIG. 4A, the second shaft 412 may be parallel to the first shaft 102. By comparison, as depicted in FIG. 4C, the arm rod 438 and integrated second shaft socket 440 and second shaft rod 442 may be rotated to a non-parallel longitudinal orientation relative to the first shaft 102. In this arrangement, the two shaft alignment device 100 may be customizable to different alignment aperture orientations. For example, as depicted in FIGS. 2A-2C, the alignment apertures 218-1, 218-2, 220-1, and 220-2 may be on the same plane. However, in other examples, the alignment apertures may be in different planes. Accordingly, the customized and adjustable length and orientation of the arm 410 facilitates the use of the two shaft alignment device 100 in different scenarios.

As depicted in FIG. 4D, in an example, the arm 410 includes an arm set screw 444 to lock the arm rod 438 in place relative to the arm socket 436. For example, it may be undesirable for the arm 410 to adjust length and/or orientation while in use. To prevent movement once a desired length and orientation for the arm 410 is set, an operator may tighten a threaded arm set screw 444 against a portion of the arm rod 438 that is inserted in the arm socket 436 to prevent the translation and rotation of the arm rod 438 relative to the arm socket 436.

In addition to extending the arm 410, the detachable alignment device 434 of FIGS. 4A-4E may have an extendable second shaft 412. Specifically, the second shaft 412 is extendable away from the arm 410 in a direction perpendicular to the arm 410. As such, the second shaft 412 may be extended to have a variety of longitudinal lengths, which length may be less than, equal to, or greater than the length of the first shaft 102. To facilitate the extension, the second shaft 412 may include a second shaft rod 442 inserted into, and translational relative to, a second shaft socket 440. For example, when the second shaft rod 442 is more fully seated into the second shaft socket 440, as depicted in FIG. 4A, the second shaft 412 is shorter. By comparison, when the second shaft rod 442 is more fully extended from the second shaft socket 440, as depicted in FIG. 4B, the second shaft 412 is longer.

In this arrangement, the two shaft alignment device 100 may be customizable to different alignment aperture orientations. For example, as depicted in FIGS. 2A-2C, the alignment apertures 218-1, 218-2, 220-1, and 220-2 may be on the same plane. However, in other examples, the alignment apertures may be in different planes or positions in a single plane. Accordingly, the customized and adjustable length of the second shaft 412 facilitates using the two shaft alignment device 100 in different scenarios.

Accordingly, the detachable alignment device 434, and the two shaft alignment device 100 of which it is a component, are customizable based on the characteristics of the components to be joined and the respective alignment apertures. That is, the two shaft alignment device 100 in the example depicted in FIGS. 4A-4E may be adjustable to accommodate different scenarios. More specifically, when combined with the adjustable length and orientation of the arm 410, the detachable alignment device 434 is customizable in various ways to accommodate multiple component configurations.

As depicted in FIG. 4E, in an example, the second shaft 412 includes second shaft set screws 446-1 and 446-2 to secure the second shaft rod 442 in place relative to the second shaft socket 440. For example, it may be undesirable for the second shaft 412 to adjust in length while in use. To prevent movement once a desired length for the second shaft 412 is set, an operator may tighten a threaded second shaft set screws 446-1 and 4462- against a portion of the second shaft rod 442 that is inserted in the second shaft socket 440 to prevent the translation of the second shaft rod 442 relative to the second shaft socket 440.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4E, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A device, comprising:
a first shaft insertable through first alignment apertures in components to be joined;
a sleeve coaxially surrounding a middle portion of the first shaft, the sleeve abuts a first component when the first shaft is inserted through the first alignment apertures;
a handle attached to the first shaft; and
a detachable alignment device, comprising:
a collar attachable around the first shaft;
an arm extending perpendicularly from the collar; and
a second shaft extending perpendicularly from the arm, the second shaft is insertable into second alignment apertures in the components.

2. The device of claim 1, wherein the second shaft extends perpendicularly from the arm and parallel with the first shaft.

3. The device of claim 1, further comprising:
a pair of retractable ball bearings extending out a circumference of an insertion end of the first shaft to hold the components together, the pair of retractable ball bearings press against interior walls of a pocket of a second component when the first shaft is inserted through the first alignment apertures; and
a push button on the handle, the push button selectively retracts the pair of retractable ball bearings within an interior volume of the first shaft.

4. The device of claim 1, wherein the collar comprises two semi-circular brackets joinable around the first shaft via a pair of fasteners.

5. The device of claim 1, wherein the arm is extendable away from the collar in a direction perpendicular to the first shaft.

6. The device of claim 5, wherein:
the arm comprises an arm rod inserted into, and translational relative to, an arm socket; and
the arm rod is rotatable relative to the arm socket.

7. The device of claim 6, further comprising an arm set screw to lock the arm rod in place relative to the arm socket.

8. The device of claim 1, wherein the second shaft is extendable away from the arm in a direction perpendicular to the arm.

9. The device of claim 8, wherein the second shaft comprises a second shaft rod inserted into, and translational relative to, a second shaft socket.

10. The device of claim 9, further comprising a second shaft set screw to lock the second shaft rod in place relative to the second shaft socket.
